(19) United States
(12) Patent Application Publication
(10) Pub. No.: US 2019/0133237 A1
(43) Pub. Date: May 9, 2019

(54) VISOR COATING FILM, PROTECTED EYEWEAR APPARATUS CONTAINING SAME, AND VISOR PROTECTION APPLICATION KIT

(71) Applicant: Bowman Lee FULTON, The Colony, TX (US)

(72) Inventor: Bowman Lee FULTON, The Colony, TX (US)

(21) Appl. No.: 16/025,739

(22) Filed: Jul. 2, 2018

Related U.S. Application Data
(60) Provisional application No. 62/527,762, filed on Jun. 30, 2017.

(51) Int. Cl. A42B 3/22; G02B 1/14; B32B 37/12; B32B 38/00

(52) U.S. Cl. CPC A42B 3/227; G02B 1/14; B32B 2038/0028; B32B 38/0012; B32B 2571/00; B32B 37/12

(57) ABSTRACT

A protective eyewear apparatus can include a coated visor and an anchoring element configured to removably secure the coated visor to a wearer's head. The coated visor may comprise a visor with a viewing area and a multi-layer visor coating film comprising a protective film and an adhesive layer unreleasably coupled to the protective film and releasably coupled to the visor viewing area. The multi-layer visor coating film may alternatively be included in a visor protection application kit that may additionally comprise a surface treatment solution, an adherence uniformity tool, and instructions for releasably coupling the multi-layer visor coating film to a viewing area of a visor portion of a protective eyewear apparatus. In addition, a method is provided for imparting abrasion resistance, puncture resistance, resistance to tearing, and corrosion resistance to a protective eyewear apparatus.

### RELATED APPLICATION

This application claims the priority benefit of U.S. Provisional Application No. 62/527,762, entitled “VISOR COATING FILM, PROTECTED EYEWEAR APPARATUS CONTAINING SAME, AND VISOR PROTECTION APPLICATION KIT,” filed Jun. 30, 2017, which is incorporated herein by reference in its entirety.

### FIELD

The invention set forth in the appended claims relates generally to a protective film for visors, as well as a protected eyewear apparatus and a visor protection application kit containing the protective film and a method of applying the protective film to the protected eyewear apparatus.

### BACKGROUND

Eye protection can be an important item to consider for many activities, particularly when conditions threaten immediate or shorter-term potential physical harm to eyes. Contact sports and competitive events represent common situations implicating eye protection. In football and hockey, for instance, helmets with visors are standard safety equipment. Nevertheless, even non-contact competitive events such as skiing and racquetball regularly utilize some form of visor for eye protection.

As a secondary consideration, longer-term harm to eyes can occur from external or environmental factors, such as ultraviolet (UV) light exposure. Tinting or UV absorption is well-known and may protect eyesight or longer-term eye damage. Some UV protection, however, such as tinting, can typically reduce vision as a consequence and may therefore not always be desired.

Durability and clarity, in particular, can be important for contact sports. Nevertheless, when a visor surface absorbs impact for example, it can be damaged with a scratch, crack, tear, puncture, or the like. Though that does effectively protect the eyes from harm, such damage may make a visor less durable to further impact or more extensive damage, diminishing its effectiveness over time. Additionally, instances of damage may individually or collectively impair vision going forward, which can result in a false sense of security for the wearer and potentially more serious injury.

While the benefits of protective eyewear are commonly accepted, continued improvements to visor clarity, strength, safety, and durability can be advantageous for users to protect their eyesight.

### SUMMARY

This section provides a general summary of the disclosure, and is not a comprehensive disclosure of its full scope or all of its features.

In some embodiments, a protective eyewear apparatus can include a coated visor and an anchoring element configured to removably secure the coated visor to a wearer's head. The coated visor may comprise a translucent or transparent visor with a viewing area, a protective film, and an adhesive layer coupled on a first surface to the protective film and releasably coupled on a second surface, opposite the first surface, to the viewing area of the translucent or transparent visor. The viewing area may have a horizontal viewing span and a vertical viewing span. The protective film may have a horizontal span equal to or smaller than the horizontal viewing span and a vertical span equal to or smaller than the vertical viewing span. In addition, the protective film can be configured to resist abrasion, punctures, tearing, and corrosion. In some embodiments, the protective film may be stretched to substantially cover the horizontal viewing span and the vertical viewing span of the visor viewing area. In some embodiments, a ratio of the horizontal span of the protective film to the horizontal viewing span may be from 95% to 99%. Additionally or alternatively, in some embodiments, a ratio of the vertical span of the protective film to the vertical viewing span may be from 96% to 98%.

Alternatively, in other example embodiments, a visor protection application kit may comprise, or consist essentially of, a surface treatment solution, a multi-layer visor coating film, an adherence uniformity tool, and instructions for releasably coupling the multi-layer visor coating film to a viewing area of a visor portion of a protective eyewear apparatus. In some embodiments, the surface treatment solution may comprise or consist essentially of water, a C1-C4 alcohol, and a cleaning agent. In some embodiments, the multi-layer visor coating film may comprise or consist essentially of a protective film having a horizontal span and a vertical span, an adhesive layer coupled on a first surface to the protective film, and a release layer releasably coupled to a second surface of the adhesive layer opposite the first surface. The protective film may be configured to resist abrasion, punctures, tearing, and corrosion. In addition to coupling the protective film and the release layer, the adhesive layer may be configured to be releasably coupled on the second surface to a viewing area of a visor portion of a protective eyewear apparatus.

Alternatively, in other example embodiments, a method is provided for imparting abrasion resistance, puncture resistance, resistance to tearing, and corrosion resistance to a protective eyewear apparatus. The method may include obtaining a visor protection application kit, such as described herein, comprising, or consisting essentially of, a surface treatment solution, a multi-layer visor coating film, an adherence uniformity tool, and instructions for releasably coupling the multi-layer visor coating film to a viewing area of a visor portion of the protective eyewear apparatus. In some embodiments, the multi-layer visor coating film may comprise or consist essentially of a protective film having a horizontal span and a vertical span, an adhesive layer coupled on a first surface to the protective film, and a release layer releasably coupled to a second surface of the adhesive layer opposite the first surface. The protective film may be configured to resist abrasion, punctures, tearing, and corrosion. The method may also include identifying a protective eyewear apparatus including a translucent or transparent visor with a viewing area and an anchoring element configured to removably secure the translucent or transparent visor to a wearer's head. The viewing area may have a horizontal viewing span equal to or greater than the horizontal span of the protective film and a vertical viewing span equal to or greater than the vertical span of the protective film. The release layer may be removed from the multi-layer visor coating film to expose the second surface of the adhesive layer. The viewing area of the translucent or transparent visor, and optionally also the second surface of the adhesive layer, may be treated with the surface treatment solution. The multi-layer visor coating film may then be stretched to substantially cover the viewing area of the translucent or transparent visor, thereby releasably adhering the second surface of the adhesive layer to the viewing area of the translucent or transparent visor to form a coated visor. Optionally, the adherence uniformity tool may be used to remove air pockets trapped between the second surface of the adhesive layer and the viewing area of the translucent or transparent visor, if present. The method may also include allowing the coated visor to cure, for example at ambient conditions.

Objectives, advantages, and a preferred mode of making and using the claimed subject matter may be understood best in conjunction with the following detailed description of the illustrative embodiments. These specific examples are intended for purposes of illustration only and are not intended to limit the scope of the claimed subject matter.

### DETAILED DESCRIPTION

The following description of example embodiments provides information that enables a person skilled in the art to make and use the subject matter set forth in the appended claims, but may omit certain details already well-known in the art. The following detailed description is, therefore, to be taken as illustrative and not limiting.

A protective eyewear apparatus may typically include at least a visor and an anchoring element configured to removably secure the visor to a wearer's head. The visor may typically include a viewing area having a horizontal viewing span and a vertical viewing span. In an as-worn reference frame based on a standing wearer, the horizontal viewing span can be analogous to a length of the viewing area, and the vertical viewing span can be analogous to a height of the viewing area. However, because visor viewing areas may not be approximately flat and may typically have some three-dimensionality or curvature, the side-to-side measurement herein is termed a horizontal viewing span, and the up-to-down measurement herein is termed a vertical viewing span.

The viewing area of the visor may be fabricated from any material or combination of materials and in any shape that facilitates a wearer's vision and eye protection. The viewing area may typically be substantially transparent to visible light, but may alternatively be translucent with a relatively large proportion of visible light being transmissible therethrough, for example when shaded or tinted for UV protection. Non-limiting examples of viewing area materials can include polycarbonates, acrylics, polyamides such as nylons, copolymers thereof, durable glasses, flexible metals, or layered versions thereof, so long as a combination of durability and transparency or an acceptable level of translucency can be achieved. As used herein, the term “substantially transparent,” with regard to visible light, should be understood to mean that at least 95% of visible wavelengths of light are transmitted. Visible wavelengths of light are known to range from 400 nm to 700 nm. In some embodiments, “substantially transparent” may mean that at least 97%, at least 98%, at least 99%, or about 100% of visible wavelengths are transmitted.

The protective eyewear apparatus can take any reasonable form. Non-limiting examples may include a hockey helmet with a visor, a football helmet with a visor, snow sports goggles, racquetball goggles, a vehicle helmet such as a motorcycle helmet or an auto racing helmet, an underwater mask, or sunglasses. In a particular embodiment, the protective eyewear apparatus can include a hockey helmet with a visor or a football helmet with a visor. Various protective eyewear apparatuses are available from a multitude of commercial vendors, which may vary depending upon the application. Non-limiting examples of hockey helmets with visors can include CCM 31T, Oakley PRO STRAIGHT, Bauer HDO PRO STRAIGHT, Bauer HDO PRO WAVE, Bauer CONCEPT 3, or Bauer HYBRID SHIELD, or the like. Non-limiting examples of football helmets with visors can include those manufactured by Oakley, Nike, and Under Armour, among others. For example, Oakley and Uvex are also exemplary manufacturers of both sunglasses and snow sports goggles; Python is an exemplary manufacturer of racquetball goggles; and Ocean Reef is an exemplary manufacturer of diving masks, snorkeling masks, and swim masks or goggles.

The anchoring element can take any reasonable form, depending upon the nature of the protective eyewear apparatus. For example, a helmet may be an anchoring element in some embodiments. A helmet may be used in contact sports such as hockey and football, as well as vehicle applications, and may include visors attached to helmets for entire head protection as a complement to eye protection. Other sports or hobbies, for example snowboarding, skiing, racquetball, diving, snorkeling, and swimming, may merely include fabric or elastic straps as an anchoring element for holding a visor over a wearer's eyes or to a wearer's head. Sunglasses, for example, may include arms or temples that rest on or wrap around the ears, or may include fabric or elastic straps for more active wearers.

Protective eyewear apparatuses can be obtained inclusive of an additional multi-layer visor coating film disposed over the viewing area of the visor, or an additional multi-layer visor coating film can alternatively be applied to the viewing area of the visor after-market. In either case, an additional multi-layer visor coating film, when applied to a visor viewing area of a protective eyewear apparatus, can advantageously offer extra clarity, strength, safety, and durability in some embodiments.

In some embodiments, a multi-layer visor coating film can comprise or consist essentially of a protective film, an adhesive layer coupled on a first surface to the protective film, and optionally a release layer releasably coupled to a second surface of the adhesive layer opposite the first surface. In some embodiments, such as when the multi-layer visor coating film is sold separately or applied after-market, the release layer is present and may function to protect the second surface of the adhesive layer. In some embodiments, if the multi-layer visor coating film is included with a protective eyewear apparatus, the optional release layer may not be included, and the second surface of the adhesive layer opposite the first surface may be releasably coupled to the viewing area of the visor portion of the protective eyewear apparatus instead.

Similar to the viewing area of the visor, the protective film may include a horizontal span and a vertical span. Also similar to the viewing area of the visor, the horizontal span can be analogous to a length of the protective film, and the vertical span can be analogous to a height of the protective film. Unlike visor viewing areas, however, the protective film may be approximately flat and may typically not exhibit three-dimensionality or curvature. Nevertheless, for consistency, the length or side-to-side measurement of a protective film herein is termed a horizontal span, and the height or up-to-down measurement of a protective film herein is termed a vertical span.

The protective film may be configured to resist abrasion, punctures, tearing, and corrosion. In embodiments in which the visor of the protective eyewear apparatus is also configured to resist one or more of abrasion, punctures, tearing, and corrosion, the protective film may be configured to offer additional resistance. In some embodiments, the protective film may be substantially transparent to visible light, for example so as not to impede a wearer's vision.

The protective film may be fabricated from any material or combination of materials that facilitates a wearer's vision and additional eye protection, in concert with the visor. Advantageously, the material or combination of materials can individually or collectively function to resist one or more of abrasion, punctures, tearing, and corrosion. Non-limiting examples of materials from which protective films can be made can include polyurethanes such as a polyurethane elastomer, acrylic polymers, polycarbonates, polyamides such as nylons, polyimides, polyesters such as poly(ethylene terephthalate), natural or synthetic elastomers, polyolefins, hydrogenated polyolefins, or copolymers thereof. In a particular embodiment, the protective film may comprise or may consist essentially of a polyurethane such as a polyurethane elastomer.

In some embodiments, the protective film may be elastic. In this context, a material that exhibits substantially elastic recovery under intended use conditions is termed “elastic”, and a material that does not exhibit substantially elastic recovery under intended use conditions is termed “not elastic”. In some embodiments, the protective film may be considered elastic if it exhibits at most about 1%, and advantageously at most about 0.5% or about 0%, permanent deformation when subjected to about 5% strain, relative to the length, for about 6 months at that strain level, using an Instron™ mechanical testing machine, for example, at an initial imposed strain rate of about 1% elongation per minute up to the total strain value, at which point it can be held for the total strain time. Instron™ testing may be performed at room temperature, such as −20-25° C., and at low relative humidity, for example ˜40% RH or less. Even though particular values are specified with respect to the strain test, materials, layers, or compositions may be considered elastic if optionally tested with one or more parametric deviations, including but not limited to: being conducted at a greater strain than specified (for example, between about 5% strain and about 10% strain), relative to the length; being conducted for a longer time than specified (for example, between about 8 months and about 1 year) at the total strain level; and being conducted at an initial strain rate greater specified (for example, between about 5% elongation per minute and about 5% elongation per second).

In some embodiments, the protective film can be creep-resistant. In this context, a material may be considered “creep-resistant” if it exhibits at most about 1%, and advantageously at most about 0.5% or about 0%, permanent extension and no rupture when subjected to an applied tensile stress of about 75% of its yield stress for about 3 months, following the procedures outlined in ASTM D2990-01 and ASTM D638. Even though particular values are specified with respect to the creep test, materials, layers, or compositions may be considered creep-resistant if optionally tested with one or more parametric deviations, including but not limited to, being conducted at a greater applied tensile stress than specified (for example, between about 75% and about 90% of yield stress), or being conducted for a longer time than specified (for example, between about 3 months and about 6 months). Additionally or alternatively, a material may be considered “creep-resistant” if it exhibits at most about 1%, and advantageously at most about 0.5% or about 0%, permanent extension and no rupture when subjected to an applied tensile stress of about 5% of its ultimate tensile stress for about 3 months, following the procedures outlined in ASTM D2990-01 and ASTM D638. Even though particular values are specified with respect to the creep test, materials, layers, or compositions may be considered creep-resistant if optionally tested with one or more parametric deviations, including but not limited to, being conducted at a greater applied tensile stress than specified (for example, between about 5% and about 10% of ultimate tensile stress), or being conducted for a longer time than specified (for example, between about 3 months and about 6 months).

Because the protective film portion of the multi-layer visor coating film is meant to cover the viewing area of the visor, the size and shape of the protective film may typically be dictated by the size and shape of the viewing area of the visor to be covered. In some embodiments, the protective film can have a thickness from 0.004 inches to 0.020 inches, for example from 0.005 inches to 0.015 inches.

In some embodiments, particularly embodiments in which the anchoring element is a hockey helmet or a football helmet, the viewing area of the visor can have a horizontal viewing span from 8.5 inches to 14 inches, for example from 9 inches to 12.5 inches. Additionally or alternatively, particularly embodiments in which the anchoring element is a hockey helmet or a football helmet, the viewing area of the visor can have a vertical viewing span from 2 inches to 6 inches, for example from 2.5 inches to 4.5 inches.

In some embodiments, particularly embodiments in which the anchoring element is a hockey helmet or a football helmet, the protective film can have a horizontal span from 8 inches to 14 inches, for example from 8.5 inches to 12 inches. Additionally or alternatively, particularly embodiments in which the anchoring element is a hockey helmet or a football helmet, the protective film can have a vertical span from 1.8 inches to 6 inches, for example from 2.5 inches to 4.5 inches.

The adhesive layer may be fabricated from any material or combination of materials that facilitates releasable coupling of the protective film to the viewing area of the visor and to the optional release layer. In some embodiments, the adhesive layer can function to resist one or more of abrasion, punctures, tearing, and corrosion, in addition to or in concert with the protective film. Non-limiting examples of materials from which adhesive layers can be made can include pressure-sensitive adhesives and low-tack adhesives. In some embodiments, the adhesive layer may advantageously be configured so as to unreleasably couple with the protective layer, such that releasability from the viewing area of the visor and from the optional release layer can be relatively easy in comparison to releasability from the protective layer. For example, an interfacial strength between the protective layer and the adhesive layer, once coupled, may be greater than an interfacial strength between the adhesive layer and the viewing area of the visor, thereby optionally allowing removal or reattachment to occur via an interface between the visor and the adhesive layer. In a particular embodiment, the adhesive layer can comprise an acrylic adhesive, such as a pressure-sensitive acrylic adhesive. In some embodiments, the adhesive layer may be substantially transparent to visible light, for example so as not to impede a wearer's vision.

The size and shape of the adhesive layer may typically be dictated by the size and shape of the protective film, which may also typically be dictated by the viewing area of the visor to be covered. Because of that, the adhesive layer and the multi-layer visor coating film can have side-to-side and up-to-down dimensions, such as horizontal span and vertical span, similar or identical to that of the protective film. In some embodiments, the adhesive layer can have a thickness from 0.0005 inches to 0.006 inches, for example from 0.001 inches to 0.004 inches.

In some embodiments, the protective film or the multi-layer visor coating film can be stretched in a direction of the horizontal span, in a direction of the vertical span, or in both directions, in order to substantially cover the visor viewing area. As used herein, the term “substantially cover,” with respect to a surface area having a horizontal span and a vertical span, should be understood to mean that no more than 1/16 of an inch of either or both of the horizontal and vertical spans remains uncovered. In some embodiments, “substantially cover” may mean that at least 98%, at least 98.5%, at least 99%, at least 99.5%, or about 100% of either or both of the horizontal and vertical spans are covered.

If stretching needs to occur in a horizontal direction in order to substantially cover the horizontal viewing span of the visor viewing area, then the horizontal span of the protective film may be smaller than the horizontal viewing span of the viewing area of the visor. Alternatively, the horizontal span of the protective film may be equal to the horizontal viewing span of the viewing area of the visor. If stretching needs to occur in a vertical direction in order to substantially cover the vertical viewing span of the visor viewing area, then the vertical span of the protective film may be smaller than the vertical viewing span of the viewing area of the visor. Alternatively, the vertical span of the protective film may be equal or approximately equal to the vertical viewing span of the viewing area of the visor.

In some embodiments, a ratio of the horizontal span of the protective film to the horizontal viewing span of the visor viewing area may be from 94% to 99.5%, for example from 95% to 99% or from 97% to 99%. Additionally or alternatively, a ratio of the vertical span of the protective film to the vertical viewing span may be from 94% to 99.5%, for example from 95% to 99% or from 96% to 98%. In some embodiments, a ratio of the horizontal span of the protective film to the horizontal viewing span of the visor viewing area may be approximately 100%, or a ratio of the vertical span of the protective film to the vertical viewing span of the visor viewing area may be approximately 100%. In embodiments in which the protective film is stretched only in a direction of the horizontal viewing span and not in a direction of the vertical viewing span, the ratio of the horizontal span to the horizontal viewing span may be from 95% to 99%, and the ratio of the vertical span to the vertical viewing span may be at least 97.5% or approximately 100%. In embodiments in which the protective film is stretched only in a direction of the vertical viewing span and not in a direction of the horizontal viewing span, the ratio of the vertical span to the vertical viewing span may be from 96% to 98%, and the ratio of the horizontal span to the horizontal viewing span may be at least 99% or approximately 100%. In embodiments in which the protective film is stretched both in a direction of the horizontal viewing span and in a direction of the vertical viewing span, the ratio of the horizontal span to the horizontal viewing span may be from 97% to 99%, and the ratio of the vertical span to the vertical viewing span may be from 96% to 98%. In some embodiments, the protective film may be stretched neither in a direction of the horizontal viewing span nor in a direction of the vertical viewing span, rendering both the ratio of the horizontal span to the horizontal viewing span and the ratio of the vertical span to the vertical viewing span to be approximately 100%.

Because the multi-layer visor coating film is configured for application to the visor viewing area by stretching in a horizontal span direction, in a vertical span direction, or in both directions, the protective film and the adhesive layer may individually and collectively be flexible enough to be applied to the visor by hand, for example by an adult or a teenager. In other words, the stress required to strain the protective film, and thus the multi-layer visor coating film, to substantially cover the visor viewing area should be attainable using an average human hand.

In some embodiments, multi-layer visor coating film materials, or materials representing the combination of the protective film unreleasably coupled to the adhesive layer, may be obtained commercially, though generally identified with disparate applications. For instance, polyurethane protective tapes identified for interior and exterior surfaces of aircraft are commercially available from 3M under the tradename AEROGUARD or as identified by various alphanumeric designations, which can include but are not limited to 8544, 8560, 8561, 8562, 8607, 8607R, 8663, 8663DL, 8671, 8671 HS, 8672, 8681 HS, 8693DL, and 8694DL.

When the multi-layer visor coating film is applied to the visor viewing area of a protective eyewear apparatus, the resultant visor may be considered a coated visor. Therefore, a coated visor may comprise or consist essentially of the translucent or transparent visor releasably coupled to the multi-layer visor coating film, which may comprise or consist essentially of the protective film unreleasably coupled to the adhesive layer.

In some embodiments, such as when the multi-layer visor coating film is sold separately or applied after-market, the multi-layer visor coating film can be one component of a visor protection application kit. In the visor protection application kit, the multi-layer visor coating film may consist essentially of the protective film, the adhesive layer, and the release layer. In embodiments when the multi-layer visor coating film is sold separately or applied after-market, the visor protection application kit may advantageously further include instructions for releasably coupling the multi-layer visor coating film to the viewing area of the visor portion of a protective eyewear apparatus. Optionally but preferably, the visor protection application kit may also include a surface treatment solution and an adherence uniformity tool, such as a squeegee.

The optional surface treatment solution may comprise or consist essentially of water, a C1-C4 alcohol, and a cleaning agent. Non-limiting examples of C1-C4 alcohols useful in the optional surface treatment solution may include methanol, ethanol, isopropanol, n-propanol, n-butanol, tert-butanol, isobutanol, 2-butanol, or a mixture thereof. Cleaning agents may include surfactants, soaps, inorganic salts, organic acids, inorganic acids, aprotic acids such as ammonia, organic bases, inorganic bases, or the like, or mixtures or reaction products thereof. In a particular embodiment, the cleaning agent may comprise or be a soap.

In some embodiments, the instructions can include a sequence of tasks or steps suggesting, but typically not requiring, a user to accomplish all the tasks or steps and to accomplish them in a particular order. In some embodiments, the instructions can include one step or task prior to application of the multi-layer visor coating film and five steps or tasks thereafter. The one step or task prior to application may include ensuring a clean visor viewing area surface and a clean work space, free of contaminants such as dust and other particulates that may come between the visor viewing area surface and the adhesive layer surface, thereby compromising the integrity of a releasable coupling therebetween. The first of the five steps or tasks may include removing the release layer from the adhesive layer and applying, for example using a spray bottle, the surface treatment solution over substantially the entire visor viewing area surface and substantially the entire exposed adhesive layer surface. The second of the five steps or tasks may include adhering an edge of the surface-treated adhesive surface to a corresponding edge of the surface-treated visor viewing area surface and stretching an opposing edge of the multi-layer visor coating film toward the opposing edge of the surface-treated visor viewing area. This stretching may need to be done in a horizontal span direction, in a vertical span direction, or in both directions, until the stretched visor coating film substantially covers the visor viewing area. If stretching needs to be done in both directions, the adhering can alternatively be at a corner, instead of an edge, of the surface-treated adhesive surface, with stretching toward an opposite corner of the surface-treated visor viewing area, in order to enable stretching of the visor coating film in both directions simultaneously. The third of the five steps or tasks may include applying pressure to the protective film, both in the side-to-side directions and in the up-to-down directions, in order for the visor coating film to substantially cover the viewing area of the visor and thereby form a coated visor. The fourth of the five steps or tasks may include using the adherence uniformity tool, for example the squeegee, to remove any air pockets trapped between the adhesive layer and the viewing area of visor. The fifth of the five steps or tasks may include allowing the coated visor to cure at ambient conditions, which may take from about 2 hours to about 12 hours.

An exemplary method for imparting one or more of abrasion resistance, puncture resistance, resistance to tearing, and corrosion resistance to a protective eyewear apparatus is provided. The method may typically include: identifying a protective eyewear apparatus comprising or consisting essentially of a translucent or transparent visor with a viewing area and an anchoring element; and obtaining a multi-layer visor coating film or a visor protection application kit containing a multi-layer visor coating film. In this method, the visor portion of the protective eyewear apparatus may or may not be coupled to the anchoring element, and coupling may happen before, during, or after any enumerated step, as desired. The multi-layer visor coating film may comprise or consist essentially of a protective film, an adhesive layer unreleasably coupled on a first surface to the protective film, and a release layer releasably coupled to a second surface of the adhesive layer opposite the first surface. The visor protection application kit may comprise or consist essentially of the multi-layer visor coating film, the surface treatment solution, optionally the adherence uniformity tool, and the instructions.

The method may then include removing the release layer from the multi-layer visor coating film to expose the second surface of the adhesive layer. Thereafter, the viewing area of the visor and optionally also the exposed second surface of the adhesive layer may be treated with the surface treatment solution, or with a solution comprising or consisting essentially of water, a C1-C4 alcohol, and a cleaning agent such as a soap. The method may then include stretching the multi-layer visor coating film to substantially cover the viewing area of the visor and releasably adhering the second surface of the adhesive layer to the viewing area of the visor to form a coated visor. Optionally, the method may include using the adherence uniformity tool to remove air pockets trapped between the second surface of the adhesive layer and the viewing area of the visor. The method may then include allowing the coated visor to cure at ambient conditions.

Additionally or alternatively, the claimed subject matter may include one or more of the following embodiments.

Embodiment 1. A protective eyewear apparatus comprising: a coated visor comprising: a translucent or transparent visor with a viewing area having a horizontal viewing span and a vertical viewing span; a protective film configured to resist abrasion, punctures, tearing, and corrosion, and optionally substantially transparent, the protective film having a horizontal span equal to or smaller than the horizontal viewing span and a vertical span equal to or smaller than the vertical viewing span; and an adhesive layer coupled on a first surface to the protective film and releasably coupled on a second surface, opposite the first surface, to the viewing area of the translucent or transparent visor; and an anchoring element configured to removably secure the coated visor to a wearer's head, wherein the protective film is stretched to substantially cover the horizontal viewing span and the vertical viewing span of the visor viewing area, such that a ratio of the horizontal span of the protective film to the horizontal viewing span is from 95% to 99%, a ratio of the vertical span of the protective film to the vertical viewing span is from 96% to 98%, or both.

Embodiment 2. A protective eyewear apparatus comprising: a coated visor comprising: a translucent or transparent visor with a viewing area having a horizontal viewing span and a vertical viewing span; a protective film configured to resist abrasion, punctures, tearing, and corrosion, the protective film having a horizontal span equal to or smaller than the horizontal viewing span and a vertical span equal to or smaller than the vertical viewing span; and an adhesive layer coupled on a first surface to the protective film and releasably coupled on a second surface, opposite the first surface, to the viewing area of the translucent or transparent visor; and an anchoring element configured to removably secure the coated visor to a wearer's head, wherein the protective film is substantially transparent, elastic, and creep-resistant, and wherein a ratio of the horizontal span of the protective film to the horizontal viewing span is from 95% to 99%, a ratio of the vertical span of the protective film to the vertical viewing span is from 96% to 98%, or both.

Embodiment 3. The protective eyewear apparatus of embodiment 1 or embodiment 2, wherein the horizontal viewing span is from 8.5 inches to 14 inches, wherein the vertical viewing span is from 2 inches to 6 inches, or both.

Embodiment 4. The protective eyewear apparatus of any of embodiments 1-3, wherein the protective film comprises a polyurethane elastomer.

Embodiment 5. The protective eyewear apparatus of any of embodiments 1-4, wherein the protective film has a thickness from 0.005 inches to 0.015 inches.

Embodiment 6. The protective eyewear apparatus of any of embodiments 1-5, wherein the adhesive layer comprises a pressure-sensitive acrylic adhesive.

Embodiment 7. The protective eyewear apparatus of any of embodiments 1-6, wherein the adhesive layer has a thickness from 0.001 inches to 0.004 inches.

Embodiment 8. The protective eyewear apparatus of any of embodiments 1-7, wherein the ratio of the horizontal span of the protective film to the horizontal viewing span is about 100% and the ratio of the vertical span of the protective film to the vertical viewing span is from 96% to 98%.

Embodiment 9. The protective eyewear apparatus of any of embodiments 1-7, wherein the ratio of the horizontal span of the protective film to the horizontal viewing span is from 95% to 99% and the ratio of the vertical span of the protective film to the vertical viewing span is about 100%.

Embodiment 10. The protective eyewear apparatus of any of embodiments 1-7, wherein the ratio of the horizontal span of the protective film to the horizontal viewing span is 97% to 99% and the ratio of the vertical span of the protective film to the vertical viewing span is from 96% to 98%.

Embodiment 11. The protective eyewear apparatus of any of embodiments 1-10, wherein the anchoring element is a hockey helmet or a football helmet.

Embodiment 12. A visor protection application kit comprising: a surface treatment solution comprising water, a C1-C4 alcohol, and a cleaning agent; a multi-layer visor coating film consisting essentially of: a protective film configured to resist abrasion, punctures, tearing, and corrosion, the protective film having a horizontal span and a vertical span; an adhesive layer coupled on a first surface to the protective film and configured to be releasably coupled on a second surface, opposite the first surface, to a viewing area of a visor portion of a protective eyewear apparatus; and a release layer releasably coupled to the second surface of the adhesive layer; an adherence uniformity tool; and instructions for releasably coupling the multi-layer visor coating film to the viewing area of the visor portion of the protective eyewear apparatus.

Embodiment 13. The visor protection application kit of embodiment 12, wherein the protective film: comprises a polyurethane elastomer; has a thickness from 0.005 inches to 0.015 inches; is substantially transparent; or a combination thereof.

Embodiment 14. The visor protection application kit of embodiment 12 or embodiment 13, wherein the horizontal span of the protective film is from 8.5 inches to 14 inches, wherein the vertical span of the protective film is from 2 inches to 6 inches, or both.

Embodiment 15. The visor protection application kit of any of embodiments 12-14, wherein the adhesive layer: comprises a pressure-sensitive acrylic adhesive; has a thickness from 0.001 inches to 0.004 inches; or both.

Embodiment 16. The visor protection application kit of any of embodiments 12-15, wherein the adherence uniformity tool comprises a squeegee.

Embodiment 17. The visor protection application kit of any of embodiments 12-16, wherein the instructions comprise a step of stretching the multi-layer visor coating film in a direction across the horizontal span, in a direction along the vertical span, or both, to substantially cover the viewing area of the visor portion of the protective eyewear apparatus.

Embodiment 18. A method for imparting abrasion resistance, puncture resistance, resistance to tearing, and corrosion resistance to a protective eyewear apparatus, the method comprising: obtaining a visor protection application kit according to any of embodiments 12-17; identifying a protective eyewear apparatus comprising: a translucent or transparent visor with a viewing area having a horizontal viewing span equal to or greater than the horizontal span of the protective film and a vertical viewing span equal to or greater than the vertical span of the protective film; and an anchoring element configured to removably secure the translucent or transparent visor to a wearer's head; removing the release layer from the multi-layer visor coating film to expose the second surface of the adhesive layer; treating the viewing area of the translucent or transparent visor and optionally also the second surface of the adhesive layer with the surface treatment solution; stretching the multi-layer visor coating film to substantially cover the viewing area of the translucent or transparent visor; releasably adhering the second surface of the adhesive layer to the viewing area of the translucent or transparent visor to form a coated visor; optionally using the adherence uniformity tool to remove air pockets trapped between the second surface of the adhesive layer and the viewing area of the translucent or transparent visor; and allowing the coated visor to cure at ambient conditions.

Embodiment 19. The method of embodiment 18, wherein a ratio of the horizontal span of the protective film to the horizontal viewing span of the viewing area is from 95% to 99%, a ratio of the vertical span of the protective film to the vertical viewing span of the viewing area is from 96% to 98%, or both.

Embodiment 20. The method of embodiment 18 or embodiment 19, wherein the anchoring element is a hockey helmet or a football helmet.

Example embodiments are provided to fully convey the scope of the appended claims to those who are skilled in the art. Numerous specific details are set forth such as examples of specific components, devices, and methods, to provide a thorough understanding of embodiments of the present disclosure. It should be apparent to those skilled in the art that specific details need not be employed, that example embodiments may be embodied in many different forms and that neither should be construed to limit the scope of the appended claims. In some example embodiments, well-known processes, well-known device structures, and well-known technologies are not described in detail.

The terminology used herein is for the purpose of describing particular example embodiments only and is not intended to be limiting. The terms “comprises,” “comprising,” “including,” “containing,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It should also be understood that additional or alternative steps may be employed.

Although the ordinal terms first, second, third, etc. may be used herein to describe various elements, components, regions, layers or sections, these elements, components, regions, layers or sections should not be limited by these terms. These terms may be only used to distinguish one element, component, region, layer, or section from another element, component, region, layer, or section. Terms such as “first,” “second,” and other numerical terms when used herein do not imply a sequence or order unless clearly indicated by the context. For example, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe a relationship between one element or feature and one or more other elements or features, as illustrated in the example embodiments. Spatially relative terms may be intended to encompass different orientations of the device in use or operation in addition to the orientation described in the example embodiments. For example, if a device is turned over or upside down, elements described as “below” or “beneath” other elements or features would then be oriented “above” the other elements or features. Thus, the example term “below” can encompass both an orientation of above and below. The device may be otherwise oriented, for example rotated 90 degrees or at other orientations, and the spatially relative descriptors used herein may be interpreted accordingly.

While shown in a few illustrative embodiments, a person having ordinary skill in the art will recognize that the systems, apparatuses, and methods described herein are susceptible to various changes and modifications. Moreover, descriptions of various alternatives using terms such as “or” do not require mutual exclusivity unless clearly required by the context, and the indefinite articles “a” or “an” do not limit the subject to a single instance unless clearly required by the context. Further, any feature described in connection with any one embodiment or set of embodiments may also be applicable to any other embodiment. Components may be also be combined or eliminated in various configurations for purposes of sale, manufacture, assembly, or use.

The appended claims set forth novel and inventive aspects of the subject matter described above, but the claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described herein may also be combined or replaced by alternative features serving the same, equivalent, or similar purpose without departing from the scope of the invention defined by the appended claims.

What is claimed is:

1. A protective eyewear apparatus comprising:
a coated visor comprising:
a translucent or transparent visor with a viewing area having a horizontal viewing span and a vertical viewing span;
a protective film configured to resist abrasion, punctures, tearing, and corrosion, the protective film having a horizontal span equal to or smaller than the horizontal viewing span and a vertical span equal to or smaller than the vertical viewing span; and
an adhesive layer coupled on a first surface to the protective film and releasably coupled on a second surface, opposite the first surface, to the viewing area of the translucent or transparent visor; and
an anchoring element configured to removably secure the coated visor to a wearer's head,
wherein the protective film is stretched to substantially cover the horizontal viewing span and the vertical viewing span of the visor viewing area, such that a ratio of the horizontal span of the protective film to the horizontal viewing span is from 95% to 99%, a ratio of the vertical span of the protective film to the vertical viewing span is from 96% to 98%, or both.

2. The protective eyewear apparatus of claim 1, wherein the horizontal viewing span is from 8.5 inches to 14 inches, wherein the vertical viewing span is from 2 inches to 6 inches, or both.

3. The protective eyewear apparatus of claim 1, wherein the protective film comprises a polyurethane elastomer, is substantially transparent, or both.

4. The protective eyewear apparatus of claim 1, wherein the protective film has a thickness from 0.005 inches to 0.015 inches.

5. The protective eyewear apparatus of claim 1, wherein the adhesive layer comprises a pressure-sensitive acrylic adhesive.

6. The protective eyewear apparatus of claim 1, wherein the adhesive layer has a thickness from 0.001 inches to 0.004 inches.

7. The protective eyewear apparatus of claim 1, wherein the ratio of the horizontal span of the protective film to the horizontal viewing span is about 100% and the ratio of the vertical span of the protective film to the vertical viewing span is from 96% to 98%.

8. The protective eyewear apparatus of claim 1, wherein the ratio of the horizontal span of the protective film to the horizontal viewing span is from 95% to 99% and the ratio of the vertical span of the protective film to the vertical viewing span is about 100%.

9. The protective eyewear apparatus of claim 1, wherein the ratio of the horizontal span of the protective film to the horizontal viewing span is 97% to 99% and the ratio of the vertical span of the protective film to the vertical viewing span is from 96% to 98%.

10. The protective eyewear apparatus of claim 1, wherein the anchoring element is a hockey helmet or a football helmet.

11. A protective eyewear apparatus comprising:
a coated visor comprising:
a translucent or transparent visor with a viewing area having a horizontal viewing span and a vertical viewing span;
a protective film configured to resist abrasion, punctures, tearing, and corrosion, the protective film having a horizontal span equal to or smaller than the horizontal viewing span and a vertical span equal to or smaller than the vertical viewing span; and
an adhesive layer coupled on a first surface to the protective film and releasably coupled on a second surface, opposite the first surface, to the viewing area of the translucent or transparent visor; and
an anchoring element configured to removably secure the coated visor to a wearer's head,
wherein the protective film is substantially transparent, elastic, and creep-resistant, and
wherein a ratio of the horizontal span of the protective film to the horizontal viewing span is from 95% to 99%, a ratio of the vertical span of the protective film to the vertical viewing span is from 96% to 98%, or both.

12. A visor protection application kit comprising:
a surface treatment solution comprising water, a C1-C4 alcohol, and a cleaning agent;
a multi-layer visor coating film consisting essentially of:
a protective film configured to resist abrasion, punctures, tearing, and corrosion, the protective film having a horizontal span and a vertical span;
an adhesive layer coupled on a first surface to the protective film and configured to be releasably coupled on a second surface, opposite the first surface, to a viewing area of a visor portion of a protective eyewear apparatus; and
a release layer releasably coupled to the second surface of the adhesive layer;
an adherence uniformity tool; and
instructions for releasably coupling the multi-layer visor coating film to the viewing area of the visor portion of the protective eyewear apparatus.

13. The visor protection application kit of claim 12, wherein the protective film: comprises a polyurethane elastomer; has a thickness from 0.005 inches to 0.015 inches; is substantially transparent; or a combination thereof.

14. The visor protection application kit of claim 12, wherein the horizontal span of the protective film is from 8.5 inches to 14 inches, wherein the vertical span of the protective film is from 2 inches to 6 inches, or both.

15. The visor protection application kit of claim 12, wherein the adhesive layer:
comprises a pressure-sensitive acrylic adhesive; has a thickness from 0.001 inches to 0.004 inches; or both.

16. The visor protection application kit of claim 12, wherein the adherence uniformity tool comprises a squeegee.

17. The visor protection application kit of claim 12, wherein the instructions comprise a step of stretching the multi-layer visor coating film in a direction across the horizontal span, in a direction along the vertical span, or both, to substantially cover the viewing area of the visor portion of the protective eyewear apparatus.

18. A method for imparting abrasion resistance, puncture resistance, resistance to tearing, and corrosion resistance to a protective eyewear apparatus, the method comprising:
obtaining a visor protection application kit according to claim 12;
identifying a protective eyewear apparatus comprising:
a translucent or transparent visor with a viewing area having a horizontal viewing span equal to or greater than the horizontal span of the protective film and a vertical viewing span equal to or greater than the vertical span of the protective film; and
an anchoring element configured to removably secure the translucent or transparent visor to a wearer's head;
removing the release layer from the multi-layer visor coating film to expose the second surface of the adhesive layer;
treating the viewing area of the translucent or transparent visor and optionally also the second surface of the adhesive layer with the surface treatment solution;
stretching the multi-layer visor coating film to substantially cover the viewing area of the translucent or transparent visor;
releasably adhering the second surface of the adhesive layer to the viewing area of the translucent or transparent visor to form a coated visor;
optionally using the adherence uniformity tool to remove air pockets trapped between the second surface of the adhesive layer and the viewing area of the translucent or transparent visor; and
allowing the coated visor to cure at ambient conditions.

19. The method of claim 18, wherein a ratio of the horizontal span of the protective film to the horizontal viewing span of the viewing area is from 95% to 99%, a ratio of the vertical span of the protective film to the vertical viewing span of the viewing area is from 96% to 98%, or both.

20. The method of claim 18, wherein the anchoring element is a hockey helmet or a football helmet.
